(19) United States
(12) Patent Application Publication
(10) Pub. No.: US 2020/0336714 A1
(43) Pub. Date: Oct. 22, 2020

(54) LIGHT PROJECTOR

(71) Applicant: Liqxtal Technology Inc., Tainan City (TW)

(72) Inventors: Hung-Shan CHEN, Tainan City (TW); Ming-Syuan CHEN, Tainan City (TW)

(21) Appl. No.: 16/391,271

(22) Filed: Apr. 22, 2019

(51) Int. Cl. H04N 9/31; G03B 21/20; G03B 21/00; G02F 1/1343; G02F 1/1334

(52) U.S. Cl. CPC H04N 9/3152; G03B 21/2006; G02F 1/1334; G02F 1/1343; G03B 21/005

(57) ABSTRACT

A light projector includes a light source, an optical phase modulator, and a liquid crystal element. The light source is configured to emit light. The optical phase modulator is configured to receive the light and to modulate a phase of the light. The liquid crystal element is configured to receive the light and to generate a patterned light. The liquid crystal element includes two substrates, two conducting electrodes, and a liquid crystal layer disposed between the conducting electrodes. The conducting electrodes are respectively disposed on the substrates. The liquid crystal layer includes plural liquid crystals dispersed in a patterned polymer structure. A pattern of the patterned light is adjustable by changing a voltage applied between the conducting electrodes.

### BACKGROUND

### Field of Invention

The present invention relates to a light projector. More particularly, the present invention relates to a light projector for providing a patterned light with an adjustable pattern.

### Description of Related Art

A light projection system integrated within the mobile phone is configured to use optical phase modulator for generating a patterned light, such as a structured light or a flood light. The patterned light projected by the light projection system may be used for face recognition by stereo image matching. However, a pattern and/or a spatial energy distribution of the patterned light cannot be varied when the design of the light projection system is completed. If there is a need for varying the pattern or the spatial energy distribution of the patterned light, the light projection system needs to be included some additional optical elements.

### SUMMARY

One aspect of the invention is directed to a light projector including a light source, an optical phase modulator, and a liquid crystal element. The light source is configured to emit light. The optical phase modulator is configured to receive the light and to modulate a phase of the light. The liquid crystal element is configured to receive the light and to generate a patterned light. The liquid crystal element includes two substrates, two conducting electrodes, and a liquid crystal layer disposed between the conducting electrodes. The conducting electrodes are respectively disposed on the substrates. The liquid crystal layer includes plural liquid crystals dispersed in a patterned polymer structure. A pattern of the patterned light is adjustable by changing a voltage applied between the conducting electrodes.

In accordance with one or more embodiments of the invention, the optical phase modulator is a diffractive optical element (DOE).

In accordance with one or more embodiments of the invention, the optical phase modulator is a microlens array (MLA).

In accordance with one or more embodiments of the invention, the light projector further includes a lens disposed between the light source and the optical phase modulator. The lens is configured to focus the light emitted from the light source.

In accordance with one or more embodiments of the invention, the light projector further includes a control driver electrically connected to the conducting electrodes. The control driver is configured to control the voltage applied between the conducting electrodes.

In accordance with one or more embodiments of the invention, the patterned polymer structure is polymer network liquid crystal (PNLC).

In accordance with one or more embodiments of the invention, the patterned polymer structure is polymer dispersed liquid crystal (PDLC).

In accordance with one or more embodiments of the invention, a spatial energy distribution of the patterned light is adjustable by adjusting a density distribution of the patterned polymer structure.

In accordance with one or more embodiments of the invention, a difference between an effective refractive index of the liquid crystals and a refractive index of the patterned polymer structure is varied by adjusting the voltage applied between the conducting electrodes.

In accordance with one or more embodiments of the invention, the patterned light is a structured light when the effective refractive index of the liquid crystals matches the refractive index of the patterned polymer structure; and the patterned light is a flood light when the effective refractive index of the liquid crystals does not match the refractive index of the patterned polymer structure.

Another aspect of the invention is directed to a light projector including a light source, an optical phase modulator, and a liquid crystal element set. The light source is configured to emit light. The optical phase modulator is configured to receive the light and to modulate a phase of the light. The liquid crystal element set is configured to receive the light and to generate a patterned light. The liquid crystal element set includes at least two liquid crystal elements. Each of the liquid crystal elements includes two substrates, two conducting electrodes, and a liquid crystal layer disposed between the conducting electrodes. The conducting electrodes are respectively disposed on the substrates. The liquid crystal layer includes plural liquid crystals dispersed in a patterned polymer structure. A pattern of the patterned light is adjustable by changing a voltage applied between the conducting electrodes of each of the liquid crystal elements.

In accordance with one or more embodiments of the invention, the optical phase modulator is a diffractive optical element (DOE).

In accordance with one or more embodiments of the invention, the optical phase modulator is a microlens array (MLA).

In accordance with one or more embodiments of the invention, the light projector further includes a lens disposed between the light source and the optical phase modulator. The lens is configured to focus the light emitted from the light source.

In accordance with one or more embodiments of the invention, the light projector further includes a control driver electrically connected to the conducting electrodes. The control driver is configured to control the voltage applied between the conducting electrodes of each of the liquid crystal elements.

In accordance with one or more embodiments of the invention, the patterned polymer structure is polymer network liquid crystal (PNLC).

In accordance with one or more embodiments of the invention, the patterned polymer structure is polymer dispersed liquid crystal (PDLC).

In accordance with one or more embodiments of the invention, a spatial energy distribution of the patterned light is adjustable by adjusting a density distribution of the patterned polymer structure.

In accordance with one or more embodiments of the invention, a difference between an effective refractive index of the liquid crystals and a refractive index of the patterned polymer structure is varied by adjusting the voltage applied between the conducting electrodes of each of the liquid crystal elements.

In accordance with one or more embodiments of the invention, the patterned light is a structured light when the effective refractive index of the liquid crystals matches the refractive index of the patterned polymer structure; and the patterned light is a flood light when the effective refractive index of the liquid crystals does not match the refractive index of the patterned polymer structure.

### BRIEF DESCRIPTION OF THE DRAWINGS

The invention can be more fully understood by reading the following detailed description of the embodiment, with reference made to the accompanying drawings as follows:

FIGS. 1A and 1B illustrate a light projector according to a first embodiment of the present invention.

FIGS. 2A and 2B respectively illustrate a central enhanced spatial energy distribution and an edge enhanced spatial energy distribution of a patterned light according to the first embodiment of the present invention.

FIGS. 3A and 3B illustrate a light projector according to a second embodiment of the present invention.

FIG. 4 illustrates a light projector according to a third embodiment of the present invention.

FIG. 5 illustrates a light projector according to a fourth embodiment of the present invention.

FIG. 6 illustrates a light projector according to a fifth embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

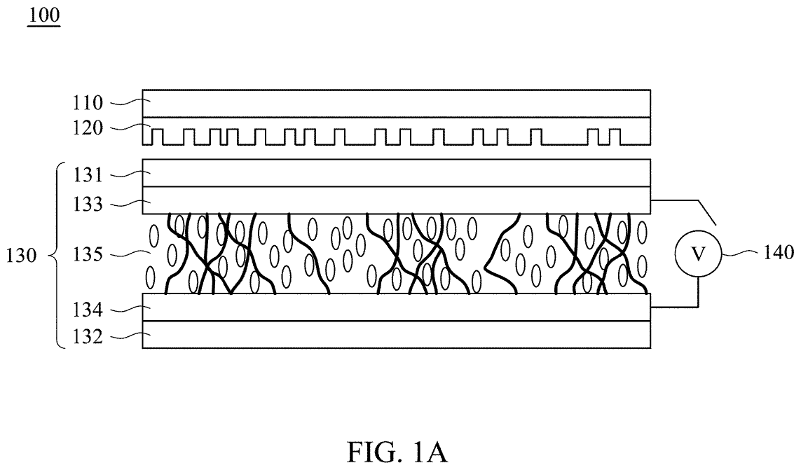

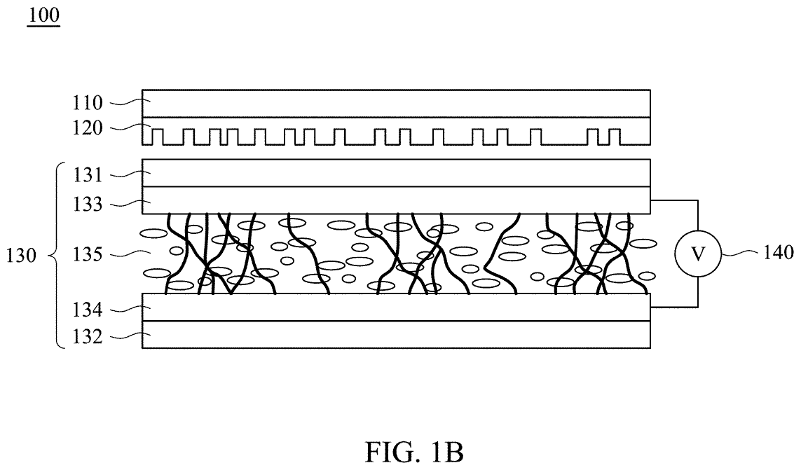

FIGS. 1A and 1B illustrate a light projector 100 according to a first embodiment of the present invention. The light projector 100 includes a light source 110, an optical phase modulator 120, a liquid crystal element 130, and a control driver 140. The optical phase modulator 120 is disposed between the light source 110 and the liquid crystal element 130.

The light source 110 is configured to emit light. The optical phase modulator 120 is configured to receive the light emitted from the light source 110 and to modulate a phase of the light emitted from the light source 110. The liquid crystal element 130 is configured to receive the modulated light emitted from the optical phase modulator 120 and to generate a patterned light for projecting onto a screen or a face (not shown).

In the first embodiment of the present invention, the optical phase modulator 120 may be a diffractive optical element (DOE) or a microlens array (MLA). In another embodiment of the present invention, the light projector may further include a lens disposed between the light source and the optical phase modulator, thereby focusing the light emitted from the light source.

As shown in FIGS. 1A and 1B, the liquid crystal element 130 includes two substrates 131 and 132, two conducting electrodes 133 and 134, and a liquid crystal layer 135. The substrate 131 is disposed on the conducting electrode 133, and the conducting electrode 134 is disposed on the substrate 132. Therefore, the conducting electrodes 133 and 134 are disposed between the substrates 131 and 132. The control driver 140 is electrically connected to the conducting electrodes 133 and 134. The control driver 140 is configured to control a voltage applied between the conducting electrodes 133 and 134.

The liquid crystal layer 135 includes plural liquid crystals dispersed in a patterned polymer structure. As shown in FIGS. 1A and 1B, there is a density distribution presented in the patterned polymer structure of the liquid crystal layer 135 of the light projector 100. In the first embodiment of the present invention, the patterned polymer structure is polymer network liquid crystal (PNLC), and the liquid crystals are liquid crystals with negative anisotropy. As shown in FIG. 1A, there is no voltage applied between the conducting electrodes 133 and 134, and the liquid crystals are orientated in the direction perpendicular to an extending direction of the conducting electrodes 133 and 134. In the case of FIG. 1A, an effective refractive index of the liquid crystals matches a refractive index of the patterned polymer structure, and thus the patterned light projected by the liquid crystal element 130 in FIG. 1A is a structured light.

As shown in FIG. 1B, there is an appropriate voltage applied between the conducting electrodes 133 and 134, and the liquid crystals are orientated in the direction perpendicular to a direction of the electric field formed between the conducting electrode 133 and the conducting electrode 134 due to the characteristic of the liquid crystals with negative anisotropy. In the case of FIG. 1B, the effective refractive index of the liquid crystals does not match the refractive index of the patterned polymer structure, and thus the patterned light projected by the liquid crystal element 130 in FIG. 1B is a flood light.

In other words, a pattern of the patterned light projected by the liquid crystal element 130 is adjustable by changing the voltage applied between the conducting electrodes 133 and 134. When changing the voltage applied between the conducting electrodes 133 and 134, a difference between the effective refractive index of the liquid crystals and the refractive index of the patterned polymer structure is varied, and thus the pattern of the patterned light projected by the liquid crystal element 130 is varied accordingly. Thus, a spatial energy distribution of the patterned light may be adjustable by appropriately controlling the voltage applied between the conducting electrodes 133 and 134.

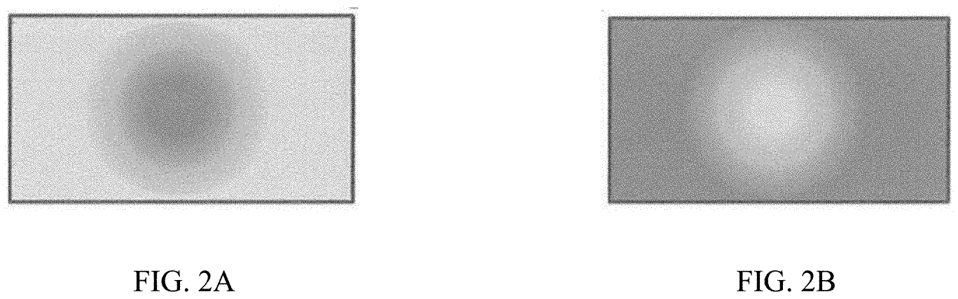

In some embodiments of the present invention, a spatial energy distribution of the patterned light is adjustable by adjusting a density distribution of the patterned polymer structure of the liquid crystal layer of the light projector. For example, the spatial energy distribution of the patterned light may be divided into a central part and a peripheral part based on a specific design of the density distribution of the patterned polymer structure of the liquid crystal layer 135, and a light intensity of the central part of the patterned light is higher than a light intensity of the peripheral part of the patterned light, and therefore the spatial energy distribution of the patterned light is central enhanced, as shown in FIG. 2A. For another example, the spatial energy distribution of the patterned light may be divided into the central part and the peripheral part based on another specific design of the density distribution of the patterned polymer structure of the liquid crystal layer 135, and a light intensity of the central part of the patterned light is lower than a light intensity of the peripheral part of the patterned light, and therefore the spatial energy distribution of the patterned light is edge enhanced, as shown in FIG. 2B. Regarding the gray level images as shown in FIGS. 2A and 2B, the darker gray represents the higher light intensity and the lighter gray represents the lower light intensity. For another example, the spatial energy distribution of the patterned light may be divided into an intermediate part and a corner part based on another specific design of the density distribution of the patterned polymer structure of the liquid crystal layer 135, and a light intensity of the intermediate part of the patterned light is lower than a light intensity of the corner part of the patterned light, and therefore the spatial energy distribution of the patterned light is corner enhanced. Specifically, the spatial energy distribution of the patterned light may be spatially adjusted by adjusting the density distribution of the patterned polymer structure of the liquid crystal layer of the light projector.

In some embodiments of the present invention, the pattern of the patterned light also depends on the design of the light source and/or the optical phase modulator, and therefore the density distribution of the patterned polymer structure of the liquid crystal layer is required to be designed according to the design of the light source and the optical phase modulator. Specifically, the density distribution of the patterned polymer structure of the liquid crystal layer is designed to be aligned with the light beams emitted from the light source and the optical phase modulator.

It is worth mentioning that the present invention does not limit the design of the density distribution of the patterned polymer structure of the liquid crystal layer. That is, the density distribution of the patterned polymer structure of the liquid crystal layer may be regular or irregular, or the distribution density of the patterned polymer structure of the liquid crystal layer may be higher or lower than a density of the light beams of the light source.

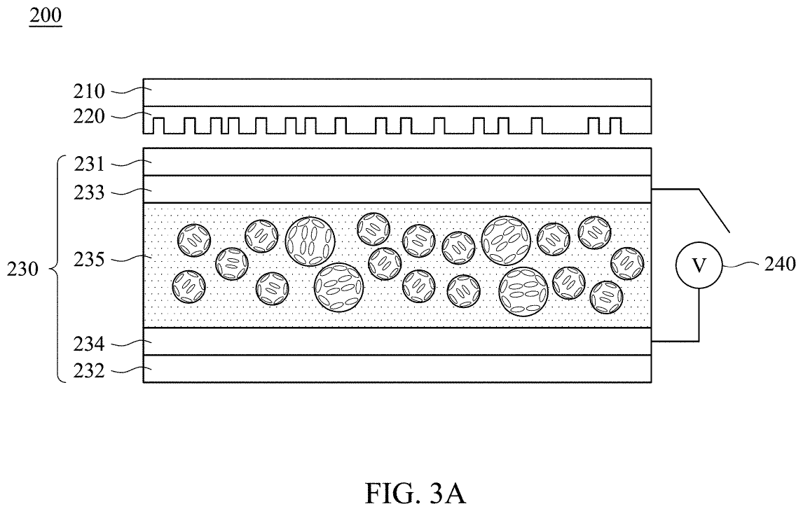

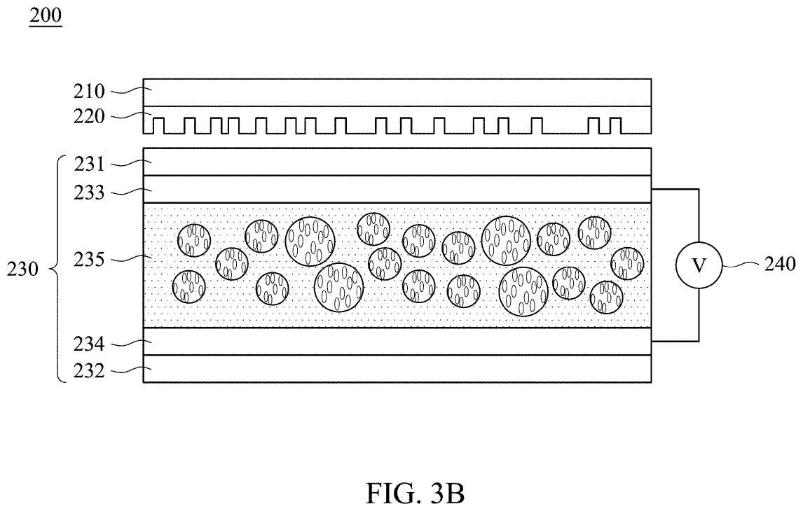

FIGS. 3A and 3B illustrate a light projector 200 according to a second embodiment of the present invention. The light projector 100 includes a light source 210, an optical phase modulator 220, a liquid crystal element 230, and a control driver 240. The optical phase modulator 220 is disposed between the light source 210 and the liquid crystal element 230.

The light source 210 is configured to emit light. The optical phase modulator 220 is configured to receive the light emitted from the light source 210 and to modulate a phase of the light emitted from the light source 210. The liquid crystal element 230 is configured to receive the modulated light emitted from the optical phase modulator 220 and to generate a patterned light for projecting onto a screen or a face (not shown). In the second embodiment of the present invention, the optical phase modulator 220 may be a diffractive optical element (DOE) or a microlens array (MLA).

As shown in FIGS. 3A and 3B, the liquid crystal element 230 includes two substrates 231 and 232, two conducting electrodes 233 and 234, and a liquid crystal layer 235. The substrate 231 is disposed on the conducting electrode 233, and the conducting electrode 234 is disposed on the substrate 232. Therefore, the conducting electrodes 233 and 234 are disposed between the substrates 231 and 232. The control driver 240 is electrically connected to the conducting electrodes 233 and 234. The control driver 240 is configured to control a voltage applied between the conducting electrodes 233 and 234.

The liquid crystal layer 235 includes plural liquid crystals dispersed in a patterned polymer structure. As shown in FIGS. 3A and 3B, there is a spatial distribution presented as different droplet sizes in the patterned polymer structure of the liquid crystal layer 235 of the light projector 200. In the second embodiment of the present invention, the patterned polymer structure is polymer dispersed liquid crystal (PDLC), and the liquid crystals are liquid crystals with positive anisotropy. As shown in FIG. 3A, there is no voltage applied between the conducting electrodes 233 and 234, and the liquid crystals are orientated in several random directions. In the case of FIG. 3A, an effective refractive index of the liquid crystals does not match a refractive index of the patterned polymer structure, and thus the patterned light projected by the liquid crystal element 230 in FIG. 3A is a flood light.

As shown in FIG. 3B, there is an appropriate voltage applied between the conducting electrodes 233 and 234, and the liquid crystals are orientated in the direction parallel to a direction of the electric field formed between the conducting electrode 233 and the conducting electrode 234 due to the characteristic of the liquid crystals with positive anisotropy. In the case of FIG. 3B, the effective refractive index of the liquid crystals matches the refractive index of the patterned polymer structure, and thus the patterned light projected by the liquid crystal element 230 in FIG. 3B is a structured light.

In other words, a pattern of the patterned light projected by the liquid crystal element 230 is adjustable by changing the voltage applied between the conducting electrodes 233 and 234. When changing the voltage applied between the conducting electrodes 233 and 234, a difference between the effective refractive index of the liquid crystals and the refractive index of the patterned polymer structure is varied, and thus the pattern of the patterned light projected by the liquid crystal element 230 is varied accordingly.

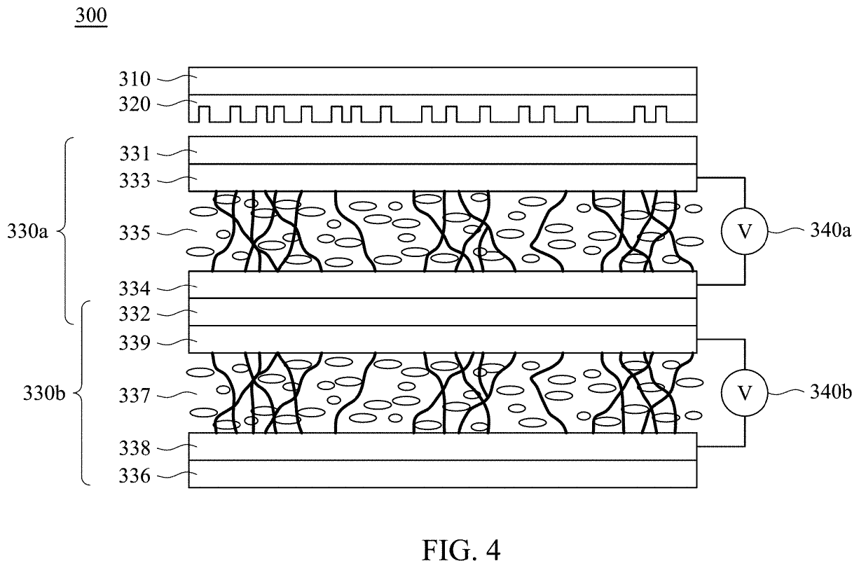

FIG. 4 illustrates a light projector 300 according to a third embodiment of the present invention. The light projector 300 includes a light source 310, an optical phase modulator 320, a liquid crystal element set, and two control drivers 340a and 340b. The liquid crystal element set includes two liquid crystal elements 330a and 330b. The optical phase modulator 320 is disposed between the light source 310 and the liquid crystal elements 330a and 330b. It is noted that the present invention does not limit the number of the liquid crystal elements of the liquid crystal element set of the light projector. That is, the liquid crystal element set of the light projector of the present invention may include more than two liquid crystal elements.

The light source 310 is configured to emit light. The optical phase modulator 320 is configured to receive the light emitted from the light source 310 and to modulate a phase of the light emitted from the light source 310. The liquid crystal elements 330a and 330b are configured to receive the modulated light emitted from the optical phase modulator 320 and to generate a patterned light for projecting onto a screen or a face (not shown). In the third embodiment of the present invention, the optical phase modulator 320 may be a diffractive optical element (DOE) or a microlens array (MLA).

As shown in FIG. 4, the liquid crystal element 330a includes two substrates 331 and 332, two conducting electrodes 333 and 334, and a liquid crystal layer 335. The liquid crystal element 330b includes two substrates 332 and 336, two conducting electrodes 338 and 339, and a liquid crystal layer 337. The substrate 331 is disposed on the conducting electrode 333, and the conducting electrode 334 is disposed on the substrate 332. The substrate 332 is disposed on the conducting electrode 339, and the conducting electrode 338 is disposed on the substrate 336. Therefore, the conducting electrodes 333 and 334 are disposed between the substrates 331 and 332, and the conducting electrodes 338 and 339 are disposed between the substrates 332 and 336. The control driver 340a is electrically connected to the conducting electrodes 333 and 334, and the control driver 340b is electrically connected to the conducting electrodes 338 and 339. The control driver 340a is configured to control a voltage applied between the conducting electrodes 333 and 334 and the control driver 340b is configured to control a voltage applied between the conducting electrodes 338 and 339. It is noted that the liquid crystal elements 330a and 330b share the substrate 332.

Each of the liquid crystal layers 335 and 337 is substantially the same as the liquid crystal layer 135, and the descriptions of the liquid crystal layers 335 and 337 are not repeated. Specifically, a pattern of the patterned light projected by the light source 310 is adjustable by changing the voltage applied between the conducting electrodes 333 and 334 and/or changing the voltage applied between the conducting electrodes 338 and 339. When changing the voltage applied between the conducting electrodes 333 and 334, a difference between the effective refractive index of the liquid crystals of the liquid crystal layer 335 and the refractive index of the patterned polymer structure of the liquid crystal layer 335 is varied, and thus the pattern of the patterned light projected by the liquid crystal element 330a is varied accordingly. When changing the voltage applied between the conducting electrodes 338 and 339, a difference between the effective refractive index of the liquid crystals of the liquid crystal layer 337 and the refractive index of the patterned polymer structure of the liquid crystal layer 337 is varied, and thus the pattern of the patterned light projected by the liquid crystal element 330b is varied accordingly.

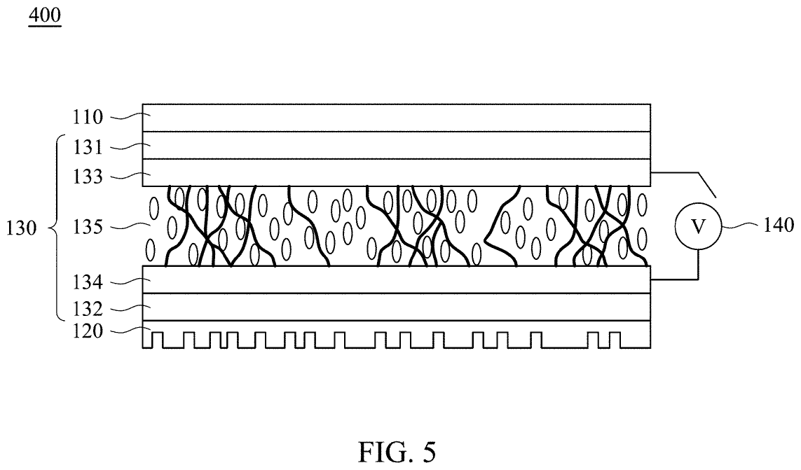

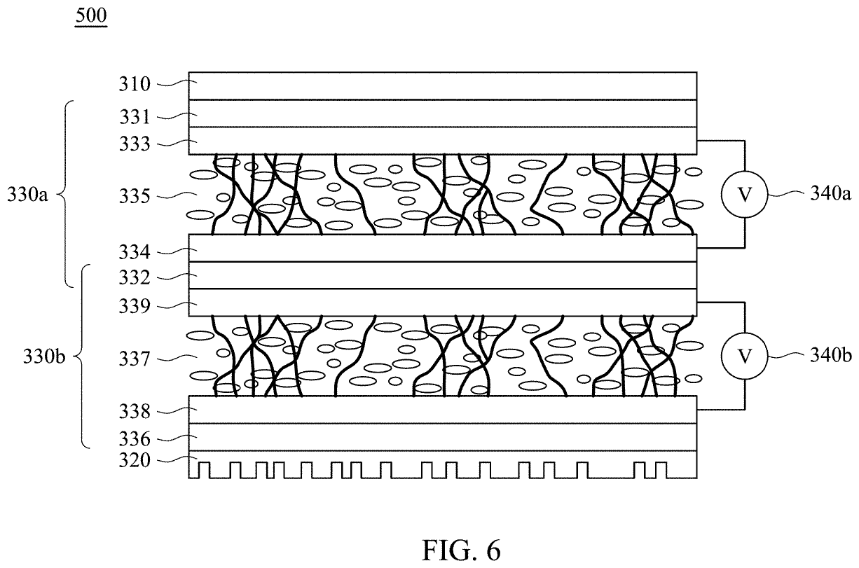

It is noted that, in other embodiments of the present invention, the liquid crystal element can be also disposed between the light source and the optical phase modulator. For example, FIG. 5 illustrates a light projector 400 according to a fourth embodiment of the present invention. As shown in FIG. 5, the liquid crystal element 130 of the light projector 400 is disposed between the light source 110 of the light projector 400 and the optical phase modulator 120 of the light projector 400. It is noted that, in other embodiments of the present invention, the liquid crystal element set can be also disposed between the light source and the optical phase modulator. For example, FIG. 6 illustrates a light projector 500 according to a fifth embodiment of the present invention. As shown in FIG. 6, the liquid crystal element set of the light projector 500 including the liquid crystal elements 330a and 330b is disposed between the light source 310 of the light projector 500 and the optical phase modulator 320 of the light projector 500.

From the above description, the present invention discloses the light projector including at least one liquid crystal element. The liquid crystal element includes two conducting electrodes and the liquid crystal layer disposed between the conducting electrodes. The liquid crystal layer includes plural liquid crystals dispersed in the patterned polymer structure. The pattern of the patterned light projected by the light projector is adjustable by changing the voltage applied between the conducting electrodes. The spatial energy distribution of the patterned light projected by the light projector is adjustable by adjusting the density distribution of the patterned polymer structure.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light projector, comprising:
a light source configured to emit light;
an optical phase modulator configured to receive the light and to modulate a phase of the light; and
a liquid crystal element configured to receive the light and to generate a patterned light, wherein the liquid crystal element comprises:
two substrates;
two conducting electrodes respectively disposed on the substrates; and
a liquid crystal layer disposed between the conducting electrodes, wherein the liquid crystal layer comprises a plurality of liquid crystals dispersed in a patterned polymer structure;
wherein a pattern of the patterned light is adjustable by changing a voltage applied between the conducting electrodes.

2. The light projector of claim 1, wherein the optical phase modulator is a diffractive optical element (DOE).

3. The light projector of claim 1, wherein the optical phase modulator is a microlens array (MLA).

4. The light projector of claim 1, further comprising:
a lens disposed between the light source and the optical phase modulator and configured to focus the light emitted from the light source.

5. The light projector of claim 1, further comprising:
a control driver electrically connected to the conducting electrodes and configured to control the voltage applied between the conducting electrodes.

6. The light projector of claim 1, wherein the patterned polymer structure is polymer network liquid crystal (PNLC).

7. The light projector of claim 1, wherein the patterned polymer structure is polymer dispersed liquid crystal (PDLC).

8. The light projector of claim 1, wherein a spatial energy distribution of the patterned light is adjustable by adjusting a density distribution of the patterned polymer structure.

9. The light projector of claim 1, wherein a difference between an effective refractive index of the liquid crystals and a refractive index of the patterned polymer structure is varied by adjusting the voltage applied between the conducting electrodes.

10. The light projector of claim 9,
wherein the patterned light is a structured light when the effective refractive index of the liquid crystals matches the refractive index of the patterned polymer structure;
wherein the patterned light is a flood light when the effective refractive index of the liquid crystals does not match the refractive index of the patterned polymer structure.

11. A light projector, comprising:
a light source configured to emit light;
an optical phase modulator configured to receive the light and to modulate a phase of the light; and
a liquid crystal element set configured to receive the light and to generate a patterned light, wherein the liquid crystal element set comprises at least two liquid crystal elements, wherein each of the liquid crystal elements comprises:
two substrates;
two conducting electrodes respectively disposed on the substrates; and
a liquid crystal layer disposed between the conducting electrodes, wherein the liquid crystal layer comprises a plurality of liquid crystals dispersed in a patterned polymer structure;
wherein a pattern of the patterned light is adjustable by changing a voltage applied between the conducting electrodes of each of the liquid crystal elements.

12. The light projector of claim 11, wherein the optical phase modulator is a diffractive optical element (DOE).

13. The light projector of claim 11, wherein the optical phase modulator is a microlens array (MLA).

14. The light projector of claim 11, further comprising:
a lens disposed between the light source and the optical phase modulator and configured to focus the light emitted from the light source.

15. The light projector of claim 11, further comprising:
a control driver electrically connected to the conducting electrodes and configured to control the voltage applied between the conducting electrodes of each of the liquid crystal elements.

16. The light projector of claim 11, wherein the patterned polymer structure is polymer network liquid crystal (PNLC).

17. The light projector of claim 11, wherein the patterned polymer structure is polymer dispersed liquid crystal (PDLC).

18. The light projector of claim 11, wherein a spatial energy distribution of the patterned light is adjustable by adjusting a density distribution of the patterned polymer structure.

19. The light projector of claim 11, wherein a difference between an effective refractive index of the liquid crystals and a refractive index of the patterned polymer structure is varied by adjusting the voltage applied between the conducting electrodes of each of the liquid crystal elements.

20. The light projector of claim 19,
wherein the patterned light is a structured light when the effective refractive index of the liquid crystals matches the refractive index of the patterned polymer structure;
wherein the patterned light is a flood light when the effective refractive index of the liquid crystals does not match the refractive index of the patterned polymer structure.
